(19) United States
(12) Patent Application Publication
(10) Pub. No.: US 2024/0179106 A1
(43) Pub. Date: May 30, 2024

(54) METHOD FOR DISPLAYING RESOURCE LEVELS, ELECTRONIC DEVICE, AND STORAGE MEDIUM

(71) Applicant: BEIJING DAJIA INTERNET INFORMATION TECHNOLOGY CO., LTD., Beijing (CN)

(72) Inventor: Leibin JIAO, Beijing (CN)

(21) Appl. No.: 18/487,832

(22) Filed: Oct. 16, 2023

(30) Foreign Application Priority Data
Nov. 29, 2022 (CN) 202211510667.7

(51) Int. Cl. H04L 47/80; H04L 47/70

(52) U.S. Cl. CPC H04L 47/808; H04L 47/822

(57) ABSTRACT

Provided is a method for displaying resource levels, including: acquiring a resource-level display request, wherein the resource-level display request includes an account resource quantity and a first resource quantity, the account resource quantity is a quantity of virtual resources in an account, and the first resource quantity is a quantity of virtual resources required for exchanging a virtual gift; determining a difference value between the first resource quantity and the account resource quantity; generating, based on the difference value, a first resource level, wherein the first resource level is configured to request to acquire the virtual resources with a quantity not less than the difference value; and displaying the first resource level.

### CROSS-REFERENCE TO RELATED APPLICATIONS

This application is based on and claims priority to Chinese Patent Application No. 202211510667.7, filed on Nov. 29, 2022, the disclosure of which is herein incorporated by reference in its entirety.

### TECHNICAL FIELD

The present disclosure relates to the field of internet technologies, in particular to a method for displaying resource levels, an electronic device, and a non-transitory computer-readable storage medium.

### BACKGROUND

With the development of internet technologies, more and more users use resources in networks. In a scenario where the network resources are used, a client side shows resource levels to a user for selecting and using the network resources.

### SUMMARY

The present disclosure provides a method for displaying resource levels, an electronic device, and a non-transitory computer-readable storage medium. The technical solution of the present disclosure is as follows.

According to some embodiments of the present disclosure, a method for displaying resource levels for exchanging of a virtual gift is provided, the method is executed by an electronic device and includes:

acquiring a resource-level display request, wherein the resource-level display request includes an account resource quantity and a first resource quantity, the account resource quantity is a quantity of virtual resources in an account, and the first resource quantity is a quantity of virtual resources required for exchanging a virtual gift;

determining a difference value between the first resource quantity and the account resource quantity;

generating, based on the difference value, a first resource level, wherein the first resource level is configured to request to acquire virtual resources with a quantity not less than the difference value; and

displaying the first resource level on a resource panel shown on the electronic device.

In some embodiments, said acquiring the resource-level display request includes:

generating, in response to an exchange operation for the virtual gift, the resource-level display request in response to the account resource quantity being less than the first resource quantity.

In some embodiments, said generating, based on the difference value, the first resource level includes:

rounding the difference value to acquire a second resource quantity of virtual resources; and

generating, based on the second resource quantity, the first resource level, wherein the first resource level is configured to request to acquire the second resource quantity of virtual resources.

In some embodiments, the method further includes:

acquiring a second resource level from history resource levels, wherein the second resource level is a history resource level with the most history use times; and

said displaying the first resource level includes:

displaying the first resource level and the second resource level.

In some embodiments, said acquiring the second resource level from the history resource levels includes:

acquiring a preset quantity of second resource levels from the history resource levels.

In some embodiments, said acquiring the second resource level from the history resource levels includes:

acquiring a level use record from an offline database, wherein the level use record includes the history resource levels; and

determining, based on the level use record, the second resource level, and saving the second resource level in a cache database.

In some embodiments, the method further includes:

acquiring used resource levels from the first resource level and the second resource level; and

generating a level use record including the used resource levels, and saving the level use record in the offline database.

In some embodiments, the method further includes:

determining, based on a level use record of the account, a resource use type to which the account belongs, wherein the resource use type corresponds to at least one resource level; and

acquiring a third resource level corresponding to the resource use type;

said displaying the first resource level includes:

displaying the first resource level and the third resource level.

According to some embodiments of the present disclosure, a method for displaying resource levels for exchanging of a virtual gift is provided, the method is executed by an electronic device and includes:

generating, in response to an exchange operation for the virtual gift, a resource-level display request in response to an account resource quantity being less than a first resource quantity, wherein the resource-level display request includes the account resource quantity and a first resource quantity, the account resource quantity is a quantity of virtual resources in an account, and the first resource quantity is a quantity of virtual resources required for exchanging a virtual gift;

determining a difference value between the first resource quantity and the account resource quantity;

generating, based on the difference value, a first resource level, wherein the first resource level is configured to request to acquire virtual resources with a quantity not less than the difference value and is a minimum quantity of virtual resources required to supplement the account resource quantity for exchanging the virtual gift; and

displaying, on a resource panel, the first resource level, and at least one second resource level, wherein the second resource level is a resource level with the most history use times of the account and is determined based on a history level use record of the account.

In some embodiments, the method further includes:

displaying at least one third resource level along with the first resource level and the at least one second resource level, wherein the third resource level is a resource level with the most history use times of all account in a resource use type to which the account belongs, and the resource use type is classified based on resource levels commonly used and use frequencies of the accounts.

According to some embodiments of the present disclosure, an electronic device is provided and includes:

a processor; and

a memory configured to store instructions executable by the processor;

wherein the processor, when executing the instructions, is caused to perform the method for displaying resource levels for exchanging of the virtual gift according to any of the above embodiments.

According to some embodiments of the present disclosure, a non-transitory computer-readable storage medium storing instructions therein is provided. The instructions, when executed by a processor of an electronic device, cause the electronic device to perform the method for displaying resource levels for exchanging of the virtual gift according to any of the above embodiments.

### BRIEF DESCRIPTION OF DRAWINGS

FIG. 1 is a flowchart of a method for displaying resource levels according to some embodiments of the present disclosure;

FIG. 2 is a schematic diagram of a resource panel according to some embodiments of the present disclosure;

FIG. 3 is a block diagram of an apparatus for displaying resource levels according to some embodiments of the present disclosure; and

FIG. 4 is a block diagram of an electronic device according to some embodiments of the present disclosure.

### DETAILED DESCRIPTION

To make those ordinary skilled in the art better understand technical solutions of the present disclosure, the technical solutions in the embodiments of the present disclosure will be clearly and completely described below in conjunction with the accompanying drawings.

It should be noted that the terms “first”, “second” and the like in the description and claims of the present disclosure and the above drawings are configured to distinguish similar objects, and are not necessarily configured to describe a specific order or sequence. It should be understood that the data as used can be interchanged under appropriate circumstances, so that the embodiments of the present disclosure described herein can be implemented in other orders than those illustrated or described herein. The implementations described in the following embodiments do not represent all implementations consistent with the present disclosure. Instead, they are merely examples of apparatuses and methods consistent with aspects of the present disclosure as recited in the appended claims.

In some practices, in the scenario where network resources are used, a client side shows resource levels to a user. The network resources may be virtual resources. In some applications, the virtual resources can be used to exchange virtual gifts. Typically, the resource levels displayed by the client side are all fixed levels for exchanging the virtual gift, which cannot meet the needs of different users, resulting in lower use efficiency of the resource levels. Moreover, when the user wants to buy a certain virtual gift, the quantity of virtual resources in the current account may not be enough to pay for the virtual gift, the user needs to calculate the amount of the virtual resources needed to be recharged by oneself, and select an appropriate recharge level on a recharge panel for recharging. However, the user possibly makes a mistake in calculation and needs to recharge again, resulting in lower efficiency of a recharge operation and affecting the recharge experience of the user. To solve at least some of the issues discussed above, the present disclosure provides the following technical solution.

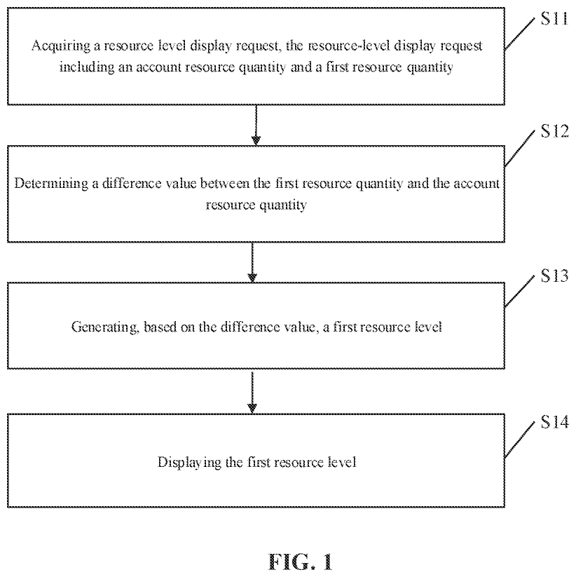

FIG. 1 is a flowchart of a method for displaying resource levels according to some embodiments of the present disclosure. As shown in FIG. 1, the method for displaying resource levels is executed by an electronic device, such as a server, a mobile phone, a computer, or a tablet computer, and includes the following steps.

In step S11, a resource-level display request is acquired, and the resource-level display request includes an account resource quantity and a first resource quantity.

The first resource quantity is a resource quantity corresponding to a virtual gift currently selected by the user, that is, the quantity of virtual resources required for exchanging the virtual gift, and the virtual gift currently selected by the user is the virtual gift to be purchased currently by the user. The account resource quantity is a resource quantity currently available in an account of the user, that is, the quantity of the virtual resources in the account.

In some embodiments, when wanting to purchase a certain virtual gift through an electronic device, the user performs an exchange operation for the virtual gift, and the exchange operation is a click operation for the virtual gift. If the account resource quantity is less than the first resource quantity corresponding to the virtual gift, the resource-level display request is generated, so as to acquire the resource-level display request. The resource-level display request includes the account resource quantity and the first resource quantity, and the electronic device analyzes the resource-level display request to acquire the account resource quantity and the first resource quantity.

In step S12, a difference value between the first resource quantity and the account resource quantity is determined.

The resource-level display request is acquired in response to the account resource quantity being less than the first resource quantity, that is, the resource-level display request is acquired when it is determined that the quantity of the virtual resources in the account is less, the virtual resources in the account are not enough for exchanging the virtual gift, and additional virtual resources need to be acquired, or the virtual resources in the account need to be supplemented, so that the virtual resources in the account are enough for exchanging the virtual gift. The resource levels in the embodiments of the present disclosure are configured to request to acquire the virtual resources, and different resource levels are configured to request to acquire the virtual resources of different amounts. In other words, the resource levels are the quantity of virtual resources recommended to the user to acquire so that the exchange of the virtual gift is possible, and after the user acquires the virtual resources by selecting the resource levels or the user's account is recharged with the acquired amount, the total quantity of the in the account (including the virtual resources acquired this time) is enough for exchanging the virtual gift. In order to accurately recommend the resource levels that can ensure a sufficient quantity of virtual resources, the electronic device determines the difference value between the first resource quantity and the account resource quantity. The difference value between the first resource quantity and the account resource quantity is also the quantity of the virtual resources that needs to be acquired for exchanging the virtual gift.

In step S13, a first resource level is generated based on the difference value.

The electronic device generates the first resource level based on the difference value, and the first resource level is configured to request to acquire the virtual resources with a quantity not less than the difference value.

In some embodiments, generating, by the electronic device, the first resource level based on the difference value includes: rounding the difference value to acquire a second resource quantity, and generating the first resource level based on the second resource quantity, wherein the first resource level is configured to request to acquire the second resource quantity of virtual resources. Rounding the difference value refers to rounding the difference value upwards.

The electronic device rounds the difference value between the first resource quantity and the account resource quantity upwards to acquire the second resource quantity, the second resource quantity is taken as a resource quantity requested to be acquired by the first resource level, that is, in response to the difference value being not an integer, the integer value greater than the difference value and closest to the difference value is taken as the quantity of the virtual resources requested to be acquired by the first resource level, so that the sum of the resource quantity requested to be acquired by the first resource level and the account resource quantity is not less than the first resource quantity, so as to exchange the virtual gift, thereby improving the use efficiency of the first resource level displayed to the user.

In step S14, the first resource level is displayed.

After the first resource level is generated, the electronic device displays the first resource level in a resource panel. The resource panel is configured to display at least one resource level, each resource level is configured to request to acquire the virtual resources, and different resource levels are configured to request to acquire the virtual resources of different quantities. The user acquires the virtual resources of the resource quantity indicated by any resource level by performing a selection operation for the resource level, and acquiring the virtual resources by the user refers to recharging the virtual resources in the account of the user. The resource panel may also be referred to as a resource recharge panel.

In some embodiments, in response to acquiring the first resource level, the electronic device also acquires other resource levels to acquire a plurality of resource levels and displays the first resource level and other resource levels in the resource panel. In response to the first resource level and other resource levels being displayed, the first resource level and other resource levels are displayed differently, and the user can select to use with any resource level based on the displayed various resource levels. In some embodiments, the first resource level may be displayed differently from other resource levels, for example, the first resource level is highlighted, or the word “recommended” is displayed in the first resource level, or the first resource level is displayed in a selected form.

In the method for displaying resource levels according to the embodiments of the present disclosure, in response to the resource-level display request being acquired, the difference value between the first resource quantity and the account resource quantity in the resource-level display request is determined, and the first resource level is generated based on the difference value and displayed. The first resource level is acquired by subtracting the account resource quantity from the first resource quantity, and the first resource quantity refers to the quantity of the virtual resources required for exchanging the virtual gift. By displaying the first resource level, it is convenient for the user to directly select the first resource level for use, so that the currently owned virtual resources and the virtual resources acquired through the first resource level are enough for exchanging the virtual gift, thereby improving the use efficiency of the resource levels.

In some embodiments, the method for displaying resource levels further includes: acquiring, by the electronic device, history resource levels with the most history use times as a second resource level. That is, the electronic device acquires the second resource level from the history resource levels, and the second resource level is a history resource level with the most history use times. For example, the electronic device acquires a preset quantity of second resource levels from the history resource levels.

Then displaying the first resource level in the above step S14 includes: displaying the first resource level and the second resource level.

The electronic device determines a preset quantity of history resource levels with the most history use times or history resource levels used most times by the user in the history resource levels, and takes the preset quantity of history resource levels as the second resource levels. In some examples, the preset quantity of history resource levels may include two resource levels. For example, in the history resource levels of a user account, the user has requested to acquire 60 virtual resources 20 times (used the most times), and requested to acquire 50 virtual resources 18 times (used the second most times), The second resource levels are 60 virtual resources and 50 virtual resources. In the case that the first resource level is displayed in the resource panel, the second resource levels are also displayed. In some embodiments, in the case that the first resource level and the second resource levels are displayed, the first resource level and the second resource levels are displayed differently, for example, the first resource level is displayed in a selected form. Since the second resource level is acquired based on the use habits of the user, personalized recommendation of the resource levels is realized, and more resource levels can be provided for selection by the user, thereby further improving the use efficiency of the resource levels.

It should be noted that the above second resource level is determined in response to the resource-level display request being acquired. The resource-level display request is acquired when the user clicks on the virtual gift or when the user triggers a level entry. The level entry refers to an entry requesting to display the resource levels, for example, the level entry is the level entry of a virtual resource page, an official website H5 level entry, a WeChat official account level entry, an applet level entry, and the like. In some embodiments, in response to the user triggering the level entry, the second resource level is determined without a need to determine the first resource level, the second resource level is sent to the client side, and the client side displays the second resource level. The quantity of the second resource levels is determined based on the quantity of the levels that can be displayed in the resource panel, or is a preset quantity. For example, if a resource panel may only have a space to display two second resource levels, the preset quantity of the second resource levels include two resource levels.

In some embodiments, acquiring, by the electronic device, the second resource level from the history resource levels includes: acquiring a level use record from an offline database, wherein the level use record includes the history resource levels; determining, based on the level use record, the preset quantity of history resource levels with the most history use times, and saving the preset quantity of history resource levels in a cache database. That is, the level use record is acquired from the offline database, and the level use record includes the history resource levels; based on the level use record, the second resource level is determined, and the second resource level is saved in the cache database.

The offline database is configured to store the level use record of each account, and the level use record stored in the offline database is configured for a cache task to determine the history resource levels commonly or frequently used by the account. The cache task in the server acquires the level use record of each account within a preset time period (for example, one month) from the offline database based on a statistical period (for example, every day), and counts the level use record of each account, the history use times of each history resource level by the same account are determined, the history resource levels are ranked based on the history use times, based on the ranking of the history resource levels of each account, the preset quantity of history resource levels with the most history use times or the use times ranked high of each account are selected, the preset quantity of history resource levels are taken as the second resource levels, and the second resource levels and an account identification are correspondingly saved in the cache database. In the case that the resource levels are recommended to one account, the second resource level corresponding to the account identification is directly queried from the cache database. In some embodiments, the cache database is a Redis database, which can improve the speed of data query.

In the embodiments of the present disclosure, the preset quantity of second resource levels with the most history use times are determined based on the level use record and saved in the cache database, and in response to the resource-level display request being acquired, the second resource levels are directly acquired from the cache database, thereby further improving the display efficiency of the resource levels and further improving the use efficiency of the resource levels.

In some embodiments, the method for displaying resource levels further includes: acquiring used resource levels (i.e., the resource levels successfully used or used by a user) from the first resource level and the second resource levels; and generating a level use record including the used resource levels, and saving the level use record in the offline database.

After the user used the resource level displayed by the electronic device, the electronic device acquires the used resource levels from the first resource level and the second resource levels, generates the level use record including the used resource levels, saves the level use record in an online database (for example, an SQL database), and synchronously saves the level use record from the online database to the offline database (for example, Hive) to facilitate data statistics, in order to subsequently determine the history resource levels with the most history use times. By synchronizing the level use record to the offline database, the data in the online database can be prevented from an interference caused by directly acquiring the level use record from the online database.

In some embodiments, the method for displaying resource levels further includes: determining a resource use type to which the level use record of the account belongs, and acquiring a third resource level, the third resource level is a resource level commonly used or frequently used by the accounts in the resource use type. Any resource use type corresponds to at least one resource level, and the resource level corresponding to the resource use type represents a common resource level of the accounts belonging to the resource use type. The third resource level is a predicted resource level that a user may request based on the use behaviors of a group of accounts that the user belongs and can provide an additional resource level for the user's selection.

Then displaying, by the electronic device, the first resource level includes displaying the first resource level and the third resource level.

In the embodiments of the present disclosure, the account is classified to belong to a resource use type based on the level use record of the account. The resource use type may be a type of higher resource levels or a type of lower resource levels. Based on each resource use type, the common resource levels of this resource use type are determined as the third resource level. In some embodiments, the electronic device acquires the level use record of each account at regular intervals (for example, at a fixed time every day), and determines the common resource levels and a use frequency of each account, the common resource levels are the preset quantity of history resource levels with the most history use times in the resource use type. The resource use type to which the level use record of the account belongs is determined based on the common resource levels and use frequency of the account, and the resource use type to which the account belongs is marked, for example, the resource use type is identified as a type of higher resource levels or lower resource levels. The common resource levels of all accounts belonging to the same resource use type are counted, the preset quantity of history resource levels with the most history use times of all user accounts in the same resource use type are determined. The history resource levels determined in this manner are taken as the third resource levels corresponding to the resource use type, for example, the preset quantity may be three, four, etc., and the preset quantity is determined based on the level quantity that can be displayed in the space of the resource panel. In response to acquiring the resource-level display request of one account, the electronic device acquires the third resource level corresponding to the resource use type based on the resource use type of the account, and display the first resource level and the third resource level. In some embodiments, in response to the first resource level and the third resource levels being displayed, the first resource level and the third resource levels are displayed differently. In some embodiments, the first resource level, the second resource levels and the third resource levels are displayed at the same time.

In the embodiments of the present disclosure, the resource use type to which the account belongs is determined based on the level use record of the account, the third resource level corresponding to the resource use type is acquired, and the first resource level and the third resource level are displayed, so that more resource level requirements of the user can be met.

It should be noted that the above third resource level is determined in response to the resource-level display request being acquired. The resource-level display request is acquired in response to the user clicking on the virtual gift or the user triggering a level entry. The level entry refers to an entry or an entry portal requesting to display the resource levels, for example, the level entry is the level entry of a virtual resource page, an official website H5 level entry, a WeChat official account level entry, an applet level entry, etc. In some embodiments, in response to the user triggering the level entry, at least one of the second resource level or the third resource level is determined without a need to determine the first resource level, at least one of the second resource levels or the third resource level is sent to the client side, and the client side displays at least one of the second resource levels or the third resource levels. The quantity of at least one of the second resource levels or the third resource levels is determined based on the quantity of the levels that can be displayed in a client side resource panel, or is a preset quantity. For example, in the case that the second resource level and the third resource level are sent at the same time, the total quantity of the second resource level and the third resource level is the quantity of levels that can be displayed in the client side resource panel.

It should be noted that the above second resource level and third resource level are determined based on the level use record. For the account without the level use record, that is, the account without cache data in the cache database, a preset quantity of lowest resource levels is selected from the existing resource levels, and the lowest resource levels refer to that the quantity of the virtual resources requested to be acquired is the lowest. In the case that there is a first-recharging activity level, the first-recharging activity level is displayed first. The first-charging activity level refers to a preferential exchange process when the account uses the resource level for exchanging the virtual resources for the first time.

In some embodiments, in the case that the above first resource level, second resource level and third resource level are displayed, a manual input level is displayed at the same time, and the manual input level is configured to set the quantity of the virtual resources requested to be acquired by the user, which is convenient for the user to customize the resource quantity.

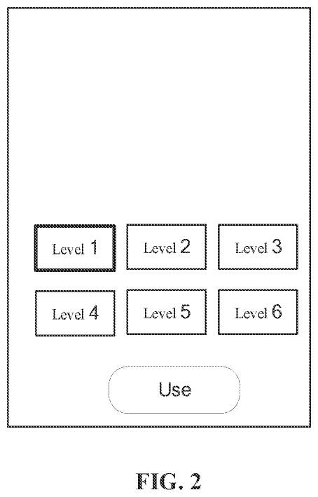

In some embodiments, the electronic device simultaneously displays the first resource level, the second resource level, and the third resource level in the resource panel, and performs a differential display to highlight the first resource level. FIG. 2 is a schematic diagram of the resource panel in some embodiments of the present disclosure. As shown in FIG. 2, the resource panel may be displayed after a user clicks on a virtual resource or a user triggers a level entry. The level entry refers to an entry requesting to display the resource levels, for example, the level entry is the level entry portal of a virtual resource page. In the resource panel in FIG. 2, six resource levels are displayed in the resource panel. Level 1 is the first resource level and the first resource level is displayed in a selected form, that is, the first resource level is displayed in a bold box in this example. The first resource level is configured to request to acquire virtual resources with a quantity not less than a difference value between the resource quantity required for exchanging a virtual resource and the resource quantity in the account. The level 2 and level 3 are different second resource levels. The second resource levels are the resource levels determined based on the history resource record of the account and are the resource levels whose use times are ranked high in the history resource record. The second resource level is determined based on a personal behavior of the user of the account. The level 4, level 5 and level 6 are different third resource levels. The third resource level are resource levels commonly used by all accounts in the resource use type to which the account belong or are the resources level whose use times are ranked high among the resource levels of all accounts in the resource use type. The third resource level can predict additional resource levels that the user may want to request to acquire for exchanging a virtual gift based on behaviors of the users of the multiple accounts in the resource use type to which the account belongs. In this way, the resource panel can display multiple resource levels for the user to select and the displayed resource levels includes the resource level that the user needs to exchange the virtual gift and the resource levels that user may want to use for the virtual gift exchange. The user can acquire the virtual resources of the resource quantity indicated by resource levels by performing a selection operation for the resource level. For example illustrated in FIG. 1, if “Level 1” indicates a resource quantity of 50, when the user clicks on the “Level 1” button, the 50 virtual resources are acquired or recharged into the account of the user. In some embodiments, the manual input level (not shown in FIG. 2) is also displayed to meet the requirement that the user customizes the resource quantity.

In some embodiments, a method for displaying resource levels for exchanging of a virtual gift, executed by an electronic device, the method including: generating, in response to an exchange operation for the virtual gift, a resource-level display request in response to an account resource quantity being less than a first resource quantity, wherein the resource-level display request includes the account resource quantity and a first resource quantity, the account resource quantity is a quantity of virtual resources in an account, and the first resource quantity is a quantity of virtual resources required for exchanging a virtual gift; determining a difference value between the first resource quantity and the account resource quantity; generating, based on the difference value, a first resource level, wherein the first resource level is configured to request to acquire virtual resources with a quantity not less than the difference value and is a minimum quantity of virtual resources required to supplement the account resource quantity for exchanging the virtual gift; and displaying, on a resource panel, the first resource level, and at least one second resource level, wherein the second resource level is a resource level with the most history use times of the account and is determined based on a history level use record of the account.

In some embodiments, the method further includes displaying at least one third resource level along with the first resource level and the at least one second resource level, wherein the third resource level is a resource level with the most history use times of all accounts in a resource use type to which the account belongs, and the resource use type is classified based on resource levels commonly used and use frequencies of the accounts.

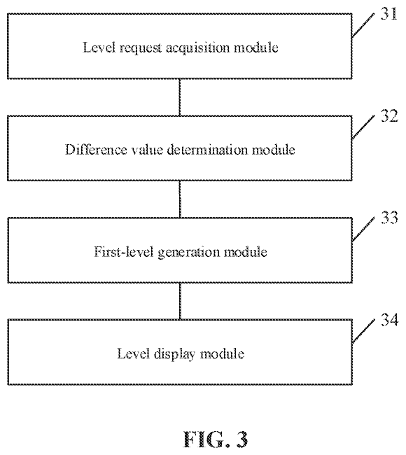

FIG. 3 is a block diagram of an apparatus for displaying resource levels according to some embodiments of the present disclosure. Referring to FIG. 3, the apparatus includes a level request acquisition module 31, a difference value determination module 32, a first-level generation module 33 and a level display module 34.

The level request acquisition module 31 is configured to acquire a resource-level display request, wherein the resource-level display request includes an account resource quantity and a first resource quantity, the account resource quantity is a quantity of virtual resources in an account, and the first resource quantity is a quantity of virtual resources required for exchanging a virtual gift;

the difference value determination module 32 is configured to determine a difference value between the first resource quantity and the account resource quantity;

the first-level generation module 33 is configured to generate, based on the difference value, a first resource level, wherein the first resource level is configured to request to acquire virtual resources with a quantity not less than the difference value; and the level display module 34 is configured to display the first resource level.

In some embodiments, the level request acquisition module 31 is configured to generate, in response to an exchange operation for the virtual gift, the resource-level display request in response to the account resource quantity being less than the first resource quantity.

In some embodiments, the first-level generation module 33 is configured to:

round the difference value to acquire a second resource quantity; and

generate, based on the second resource quantity, the first resource level, wherein the first resource level is configured to request to acquire the second resource quantity of virtual resources.

In some embodiments, the apparatus further includes:

a second-level acquisition module, configured to acquire a second resource level from history resource levels, wherein the second resource level is a history resource level with the most history use times; and

the level display module 34, configured to display the first resource level and the second resource level.

In some embodiments, the second-level acquisition module is configured to:

acquire a preset quantity of second resource levels from the history resource levels.

In some embodiments, the second-level acquisition module is configured to:

acquire a level use record from an offline database, wherein the level use record includes the history resource levels;

determine, based on the level use record, the second resource levels; and

save the second resource level in a cache database.

In some embodiments, the apparatus further includes:

a used level acquisition module, configured to acquire used resource levels from the first resource level and the second resource level; and

a use record saving module, configured to generate a level use record including the used resource levels, and save the level use record in the offline database.

In some embodiments, the apparatus further includes:

a type determination module, configured to determine, based on a level use record of the account, a resource use type to which the account belongs, wherein the resource use type corresponds to at least one resource level; and

a third-level acquisition module, configured to acquire a third resource level corresponding to the resource use type; and

the level display module 34, configured to display the first resource level and the third resource level.

With regard to the apparatus in the above embodiments, the specific ways in which respective modules perform operations have been described in detail in the method embodiments, and are not described in detail here.

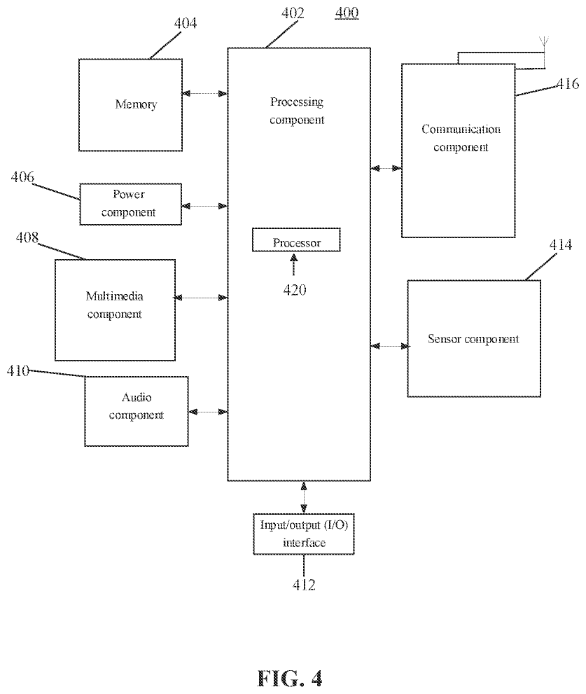

FIG. 4 is a block diagram of an electronic device according to some embodiments of the present disclosure. For example, the electronic device 400 is a mobile phone, a computer, a digital broadcasting terminal, a messaging device, a game console, a tablet device, a medical device, a fitness device or a personal digital assistant.

Referring to FIG. 4, the electronic device 400 includes one or more of the following components: a processing component 402, a memory 404, a power component 406, a multimedia component 408, an audio component 410, an input/output (I/O) interface 412, a sensor component 414, and a communication component 416.

The processing component 402 typically controls overall operations of the electronic device 400, such as the operations associated with display, telephone calls, data communications, camera operations, and recording operations. The processing component 402 includes one or more processors 420 to execute instructions to complete all or part of the steps in the above described methods. Moreover, the processing component 402 includes one or more modules which facilitate the interaction between the processing component 402 and other components. For instance, the processing component 402 includes a multimedia module to facilitate the interaction between the multimedia component 408 and the processing component 402.

The memory 404 is configured to store various types of data to support the operation of the electronic device 400. Examples of such data include instructions for any applications or methods operated on the electronic device 400, contact data, phonebook data, messages, pictures, video, etc. The memory 404 is implemented by using any type of transitory or non-transitory memory devices, or a combination thereof, such as a static random-access memory (SRAM), an electrically erasable programmable read only memory (EEPROM), an erasable programmable read only memory (EPROM), a programmable read only memory (PROM), a read only memory (ROM), a magnetic memory, a flash memory, a magnetic or optical disk.

The power component 406 provides power to various components of the electronic device 400. The power component 406 includes a power management system, one or more power sources, and any other components associated with the generation, management, and distribution of power in the electronic device 400.

The multimedia component 408 includes a screen providing an output interface between the electronic device 400 and the user. In some embodiments, the screen includes a liquid crystal display (LCD) and a touch panel (TP). In the case that the screen includes the touch panel, the screen is implemented as a touch screen to receive input signals from the user. The touch panel includes one or more touch sensors to sense touches, slips, and gestures on the touch panel. The touch sensors not only sense a boundary of a touch or slip action, but also detect a period of time and a pressure associated with the touch or slip action. In some embodiments, the multimedia component 408 includes a front camera and/or a rear camera. The front camera and the rear camera receives external multimedia data while the electronic device 400 is in an operation mode, such as a photographing mode or a video mode. Each of the front camera and the rear camera is a fixed optical lens system or has focus and optical zoom capability.

The audio component 410 is configured to output and/or input audio signals. For example, the audio component 410 includes a microphone (MIC) configured to receive an external audio signal in the case that the electronic device 400 is in an operation mode, such as a call mode, a recording mode, and a voice recognition mode. The received audio signal is further stored in the memory 404 or transmitted via the communication component 416. In some embodiments, the audio component 410 further includes a speaker to output audio signals.

The I/O interface 412 provides an interface between the processing component 402 and peripheral interface modules, such as a keyboard, a click wheel, buttons, and the like. The buttons include, but are not limited to, a home button, a volume button, a starting button, and a locking button.

The sensor component 414 includes one or more sensors to provide status assessments of various aspects of the electronic device 400. For instance, the sensor component 414 detects an open/closed status of the electronic device 400, relative positioning of components, e.g., the display and the keypad, of the electronic device 400, a change in position of the electronic device 400 or a component of the electronic device 400, a presence or absence of user contact with the electronic device 400, an orientation or an acceleration/deceleration of the electronic device 400, and a change in temperature of the electronic device 400. The sensor component 414 includes a proximity sensor configured to detect the presence of nearby objects without any physical contact. The sensor component 414 also includes a light sensor, such as a complementary metal-oxide-semiconductor (CMOS) or charge coupled device (CCD) image sensor, for use in imaging applications. In some embodiments, the sensor component 414 also includes an accelerometer sensor, a gyroscope sensor, a magnetic sensor, a pressure sensor, or a temperature sensor.

The communication component 416 is configured to facilitate communication, wired or wirelessly, between the electronic device 400 and other devices. The electronic device 400 accesses a wireless network based on a communication standard, such as WiFi, 2G, 3G, 4G or 5G or a combination thereof. In some embodiments, the communication component 416 receives a broadcast signal or broadcast associated information from an external broadcast management system via a broadcast channel. In some embodiments, the communication component 416 further includes a near field communication (NFC) module to facilitate short-range communications. For example, the NFC module is implemented based on a radio frequency identification (RFID) technology, an infrared data association (IrDA) technology, an ultra-wide band (UWB) technology, a Bluetooth (BT) technology, and other technologies.

In some embodiments, the electronic device 400 is implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above method for displaying resource levels.

The embodiments of the present disclosure further provide an electronic device, including: a processor; and

a memory configured to store instructions executable by the processor;

wherein the processor, when executing the instructions, is caused to perform:

acquiring a resource-level display request, wherein the resource-level display request includes an account resource quantity and a first resource quantity, the account resource quantity is a quantity of virtual resources in an account, and the first resource quantity is a quantity of virtual resources required for exchanging a virtual gift;

determining a difference value between the first resource quantity and the account resource quantity;

generating, based on the difference value, a first resource level, wherein the first resource level is configured to request to acquire virtual resources with a quantity not less than the difference value; and

displaying the first resource level.

In some embodiments, the processor, when executing the instructions, is caused to perform:

generating, in response to an exchange operation for the virtual gift, the resource-level display request in response to the account resource quantity being less than the first resource quantity.

In some embodiments, the processor, when executing the instructions, is caused to perform:

rounding the difference value to acquire a second resource quantity; and

generating, based on the second resource quantity, the first resource level, wherein the first resource level is configured to request to acquire the second resource quantity of virtual resources.

In some embodiments, the processor, when executing the instructions, is caused to perform:

acquiring a second resource level from history resource levels, wherein the second resource level is a history resource level with the most history use times; and

displaying the first resource level and the second resource level.

In some embodiments, the processor, when executing the instructions, is caused to perform:

acquiring a preset quantity of second resource levels from the history resource levels.

In some embodiments, the processor, when executing the instructions, is caused to perform:

acquiring a level use record from an offline database, wherein the level use record includes the history resource levels; and

determining, based on the level use record, the second resource level, and saving the second resource level in a cache database.

In some embodiments, the processor, when executing the instructions, is caused to perform:

acquiring used resource levels from the first resource level and the second resource level; and

generating a level use record including the used resource levels, and saving the level use record in the offline database.

In some embodiments, the processor, when executing the instructions, is caused to perform:

determining, based on a level use record of the account, a resource use type to which the account belongs, wherein the resource use type corresponds to at least one resource level;

acquiring a third resource level corresponding to the resource use type; and

displaying the first resource level and the third resource level.

In the embodiments of the present disclosure, a non-transitory computer-readable storage medium storing instructions is also provided, such as the memory 404 including the instructions, and the above instructions are executable by the processor 420 of the electronic device 400 to complete the above method for recommending resource information. Optionally, the computer-readable storage medium is an ROM, an RAM, a CD-ROM, a magnetic tape, a floppy disc, an optical data storage device, and the like.

The instructions in the computer-readable storage medium, when executed by the processor of the electronic device, cause the electronic device to perform:

acquiring a resource-level display request, wherein the resource-level display request includes an account resource quantity and a first resource quantity, the account resource quantity is a quantity of virtual resources in an account, and the first resource quantity is a quantity of virtual resources required for exchanging a virtual gift;

determining a difference value between the first resource quantity and the account resource quantity;

generating, based on the difference value, a first resource level, wherein the first resource level is configured to request to acquire virtual resources with a quantity not less than the difference value; and

displaying the first resource level.

In some embodiments, the instructions in the computer-readable storage medium, when executed by the processor of the electronic device, cause the electronic device to perform:

generating, in response to an exchange operation for the virtual gift, the resource-level display request in response to the account resource quantity being less than the first resource quantity.

In some embodiments, the instructions in the computer-readable storage medium, when executed by the processor of the electronic device, cause the electronic device to perform:

rounding the difference value to acquire a second resource quantity; and

generating, based on the second resource quantity, the first resource level, wherein the first resource level is configured to request to acquire the second resource quantity of virtual resources.

In some embodiments, the instructions in the computer-readable storage medium, when executed by the processor of the electronic device, cause the electronic device to perform:

acquiring a second resource level from history resource levels, wherein the second resource level is a history resource level with the most history use times; and

displaying the first resource level and the second resource level.

In some embodiments, the instructions in the computer-readable storage medium, when executed by the processor of the electronic device, cause the electronic device to perform:

acquiring a preset quantity of second resource levels from the history resource levels.

In some embodiments, the instructions in the computer-readable storage medium, when executed by the processor of the electronic device, cause the electronic device to perform:

acquiring a level use record from an offline database, wherein the level use record includes the history resource levels; and

determining, based on the level use record, the second resource level, and saving the second resource level in a cache database.

In some embodiments, the instructions in the computer-readable storage medium, when executed by the processor of the electronic device, cause the electronic device to perform:

acquiring used resource levels from the first resource level and the second resource level; and

generating a level use record including the used resource levels, and saving the level use record in the offline database.

In some embodiments, the instructions in the computer-readable storage medium, when executed by the processor of the electronic device, cause the electronic device to perform:

determining, based on a level use record of the account, a resource use type to which the account belongs, wherein the resource use type corresponds to at least one resource level;

acquiring a third resource level corresponding to the resource use type; and

displaying the first resource level and the third resource level.

The embodiments of the present disclosure further provide a computer program product, including computer programs or computer instructions. The computer programs or computer instructions, when executed by a processor, cause the processor to perform:

acquiring a resource-level display request, wherein the resource-level display request includes an account resource quantity and a first resource quantity, the account resource quantity is a quantity of virtual resources in an account, and the first resource quantity is a quantity of virtual resources required for exchanging a virtual gift;

determining a difference value between the first resource quantity and the account resource quantity;

generating, based on the difference value, a first resource level, wherein the first resource level is configured to request to acquire virtual resources with a quantity not less than the difference value; and

displaying the first resource level.

In some embodiments, the computer programs or computer instructions, when executed by the processor, cause the processor to perform:

generating, in response to an exchange operation for the virtual gift, the resource-level display request in response to the account resource quantity being less than the first resource quantity.

In some embodiments, the computer programs or computer instructions, when executed by the processor, cause the processor to perform:

rounding the difference value to acquire a second resource quantity; and

generating, based on the second resource quantity, the first resource level, wherein the first resource level is configured to request to acquire the second resource quantity of virtual resources.

In some embodiments, the computer programs or computer instructions, when executed by the processor, cause the processor to perform:

acquiring a second resource level from history resource levels, wherein the second resource level is a history resource level with the most history use times; and

displaying the first resource level and the second resource level.

In some embodiments, the computer programs or computer instructions, when executed by the processor, cause the processor to perform:

acquiring a preset quantity of second resource levels from the history resource levels.

In some embodiments, the computer programs or computer instructions, when executed by the processor, cause the processor to perform:

acquiring a level use record from an offline database, wherein the level use record includes the history resource levels; and

determining, based on the level use record, the second resource level, and saving the second resource level in a cache database.

In some embodiments, the computer programs or computer instructions, when executed by the processor, cause the processor to perform:

acquiring used resource levels from the first resource level and the second resource level; and

generating a level use record including the used resource levels, and saving the level use record in the offline database.

In some embodiments, the computer programs or computer instructions, when executed by the processor, cause the processor to perform:

determining, based on a level use record of the account, a resource use type to which the account belongs, wherein the resource use type corresponds to at least one resource level;

acquiring a third resource level corresponding to the resource use type; and

displaying the first resource level and the third resource level.

The embodiments of the present disclosure also provide a method for recommending resource information, including:

receiving a resource level acquisition request, wherein the resource level acquisition request includes an account resource quantity and a target resource quantity;

determining a difference value between the target resource quantity and the account resource quantity;

generating, based on the difference value, a first recommended resource level; and

displaying the first recommended resource level.

In some embodiments, generating, based on the difference value, the first recommended resource level includes:

rounding the difference value to acquire the first recommended resource level.

In some embodiments, prior to displaying the first recommended resource level, the method further includes:

acquiring a preset quantity of history resource levels with the most history use times as second recommended resource levels;

displaying the first recommended resource level includes:

displaying the first recommended resource level and the second recommended resource levels.

In some embodiments, prior to acquiring the preset quantity of history resource levels with the most history use times, the method further includes:

acquiring a history level use record from an offline database, wherein the history level use record includes the history resource levels; and

determining, based on the history level use record, the preset quantity of history resource levels with the most history use times, and saving the preset quantity of history resource levels in a cache database.

In some embodiments, after displaying the first recommended resource level and the second recommended resource levels, the method further includes:

acquiring successfully used recommended resource levels from the first recommended resource level and the second recommended resource levels;

generating a level use record including the recommended resource levels, and synchronously saving the level use record in the offline database.

In some embodiments, prior to displaying the first recommended resource level, the method further includes:

determining a resource use classification corresponding to the history level use record; and

acquiring third recommended resource levels corresponding to the resource use classification;

displaying the first recommended resource level includes:

displaying the first recommended resource level and the third recommended resource levels.

Other implementations of the present disclosure will be easily conceivable by those skilled in the art from consideration of the description and practice of the present disclosure disclosed here. The present disclosure is intended to cover any variations, uses, or adaptive changes of the present disclosure, and these variations, uses, or adaptive changes follow general principles of the present disclosure and include the common general knowledge or conventional technical means, not disclosed in the present disclosure, in the art. The description and embodiments are considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. The scope of the present disclosure is only limited by the appended claims.

What is claimed is:

1. A method for displaying resource levels for exchanging of a virtual gift, executed by an electronic device, the method comprising:
acquiring a resource-level display request, wherein the resource-level display request comprises an account resource quantity and a first resource quantity, the account resource quantity is a quantity of virtual resources in an account, and the first resource quantity is a quantity of virtual resources required for exchanging a virtual gift;
determining a difference value between the first resource quantity and the account resource quantity;
generating, based on the difference value, a first resource level, wherein the first resource level is configured to request to acquire virtual resources with a quantity not less than the difference value; and
displaying the first resource level on a resource panel shown on the electronic device.

2. The method according to claim 1, wherein said acquiring the resource-level display request comprises:
generating, in response to an exchange operation for the virtual gift, the resource-level display request in response to the account resource quantity being less than the first resource quantity.

3. The method according to claim 1, wherein said generating, based on the difference value, the first resource level comprises:
rounding the difference value to acquire a second resource quantity of virtual resources; and
generating, based on the second resource quantity, the first resource level, wherein the first resource level is configured to request to acquire the second resource quantity of virtual resources.

4. The method according to claim 1, further comprising:
acquiring a second resource level from history resource levels, wherein the second resource level is a history resource level with the most history use times; and
said displaying the first resource level comprises:
displaying the first resource level and the second resource level.

5. The method according to claim 4, wherein said acquiring the second resource level from the history resource levels comprises:
acquiring a preset quantity of second resource levels from the history resource levels.

6. The method according to claim 4, wherein said acquiring the second resource level from the history resource levels comprises:
acquiring a level use record from an offline database, wherein the level use record comprises the history resource levels; and
determining, based on the level use record, the second resource level, and saving the second resource level in a cache database.

7. The method according to claim 6, wherein the method further comprises:
acquiring used resource levels from the first resource level and the second resource level; and
generating a level use record comprising the used resource levels, and saving the level use record in the offline database.

8. The method according to claim 1, further comprises:
determining, based on a level use record of the account, a resource use type to which the account belongs, wherein the resource use type corresponds to at least one resource level; and
acquiring a third resource level corresponding to the resource use type;
said displaying the first resource level comprises:
displaying the first resource level and the third resource level.

9. A method for displaying resource levels for exchanging of a virtual gift, executed by an electronic device, the method comprising:
generating, in response to an exchange operation for the virtual gift, a resource-level display request in response to an account resource quantity being less than a first resource quantity, wherein the resource-level display request comprises the account resource quantity and a first resource quantity, the account resource quantity is a quantity of virtual resources in an account, and the first resource quantity is a quantity of virtual resources required for exchanging a virtual gift;
determining a difference value between the first resource quantity and the account resource quantity;
generating, based on the difference value, a first resource level, wherein the first resource level is configured to request to acquire virtual resources with a quantity not less than the difference value and is a minimum quantity of virtual resources required to supplement the account resource quantity for exchanging the virtual gift; and
displaying, on a resource panel, the first resource level, and at least one second resource level, wherein the second resource level is a resource level with the most history use times of the account and is determined based on a history level use record of the account.

10. The method according to claim 9, wherein the method further comprises displaying at least one third resource level along with the first resource level and the at least one second resource level, wherein the third resource level is a resource level with the most history use times of all account in a resource use type to which the account belongs, and the resource use type is classified based on resource levels commonly used and use frequencies of the accounts.

11. An electronic device, comprising:
a processor; and
a memory configured to store instructions executable by the processor;
wherein the processor, when executing the instructions, is caused to perform:
acquiring a resource-level display request, wherein the resource-level display request comprises an account resource quantity and a first resource quantity, the account resource quantity is a quantity of virtual resources in an account, and the first resource quantity is a quantity of virtual resources required for exchanging a virtual gift;
determining a difference value between the first resource quantity and the account resource quantity;
generating, based on the difference value, a first resource level, wherein the first resource level is configured to request to acquire virtual resources with a quantity not less than the difference value; and
displaying the first resource level.

12. The electronic device according to claim 11, wherein the processor, when executing the instructions, is caused to perform:
generating, in response to an exchange operation for the virtual gift, the resource-level display request in response to the account resource quantity being less than the first resource quantity.

13. The electronic device according to claim 11, wherein the processor, when executing the instructions, is caused to perform:
rounding the difference value to acquire a second resource quantity of virtual resources; and
generating, based on the second resource quantity, the first resource level, wherein the first resource level is configured to request to acquire the second resource quantity of virtual resources.

14. The electronic device according to claim 11, wherein the processor, when executing the instructions, is caused to perform:
acquiring a second resource level from history resource levels, wherein the second resource level is a history resource level with the most history use times; and
displaying the first resource level and the second resource level.

15. The electronic device according to claim 14, wherein the processor, when executing the instructions, is caused to perform:
acquiring a preset quantity of second resource levels from the history resource levels.

16. The electronic device according to claim 14, wherein the processor, when executing the instructions, is caused to perform:
acquiring a level use record from an offline database, wherein the level use record comprises the history resource levels; and
determining, based on the level use record, the second resource level, and saving the second resource level in a cache database.

17. The electronic device according to claim 16, wherein the processor, when executing the instructions, is caused to perform:
acquiring used resource levels from the first resource level and the second resource level; and
generating a level use record comprising the used resource levels, and saving the level use record in the offline database.

18. The electronic device according to claim 11, wherein the processor, when executing the instructions, is caused to perform:
determining, based on a level use record of the account, a resource use type to which the account belongs, wherein the resource use type corresponds to at least one resource level;
acquiring a third resource level corresponding to the resource use type; and
displaying the first resource level and the third resource level.

19. A non-transitory computer-readable storage medium storing instructions therein, wherein the instructions, when executed by a processor of an electronic device, cause the electronic device to perform the method for displaying resource levels for exchanging of the virtual gift as defined in claim 1.

20. A non-transitory computer-readable storage medium storing instructions therein, wherein the instructions, when executed by a processor of an electronic device, cause the electronic device to perform the method for displaying resource levels for exchanging of the virtual gift as defined in claim 9.
